(19) United States
(12) Patent Application Publication
(10) Pub. No.: US 2022/0341331 A1
(43) Pub. Date: Oct. 27, 2022

(54) COMPONENT WITH A REGION TO BE COOLED AND MEANS FOR THE ADDITIVE MANUFACTURE OF SAME

(71) Applicant: Siemens Energy Global GmbH & Co. KG, Munich, Bayern (DE)

(72) Inventors: Timo Heitmann, Berlin (DE); Johannes Albert, Berlin (DE)

(73) Assignee: Siemens Energy Global GmbH & Co. KG, Munich, Bayern (DE)

(21) Appl. No.: 17/640,553

(22) PCT Filed: Jul. 9, 2020
(86) PCT No.: PCT/EP2020/069352

§ 371 Date: Mar. 4, 2022

(30) Foreign Application Priority Data
Sep. 25, 2019 (DE) 10 2019 214 667.8

(51) Int. Cl. F01D 5/18; B33Y 80/00; B33Y 10/00; B22F 10/28; F01D 25/12

(52) U.S. Cl. CPC F01D 5/187; B33Y 80/00; B33Y 10/00; B22F 10/28; F01D 25/12; F05D 2220/32; F05D 2300/175

(57) ABSTRACT

A component with a region to be cooled having a cooling channel which is arranged and designed so as to cool the region of the component during operation by a fluid flow, wherein the cooling channel is defined by a first channel side facing the region and by a second channel side facing away from the region. The first channel side forms a larger contact surface for the cooling channel than the second channel side. An additive manufacture process can produce the component.

### CROSS REFERENCE TO RELATED APPLICATIONS

This application is the US National Stage of International Application No. PCT/EP2020/069352 filed 9 Jul. 2020, and claims the benefit thereof. The International Application claims the benefit of German Application No. DE 10 2019 214 667.8 filed 25 Sep. 2019. All of the applications are incorporated by reference herein in their entirety.

### FIELD OF INVENTION

The present invention relates to a component that can be cooled or is to be cooled during operation, to a method for preparing for an additive manufacturing process, in particular a powder-bed-based additive manufacturing process, for the component, to a method for the additive manufacture of the component and to a use of orientation-dependent manufacturing artefacts for the forming of an advantageous surface finish of the component, in particular which allows an improved heat transmission during the operation of the component. Furthermore, a computer program or a computer program product is provided.

The component is advantageously intended for use in a turbomachine, advantageously in the hot gas path of a gas turbine. Accordingly, the component advantageously consists of a superalloy, in particular a nickel- or cobalt-based superalloy. The alloy may be precipitation-hardened or precipitation-hardenable.

### BACKGROUND OF INVENTION

In gas turbines, thermal energy and/or flow energy of a hot gas generated by combustion of a fuel, for example a gas, is converted into kinetic energy (rotational energy) of a rotor. For this purpose, formed in the gas turbine is a flow channel, in the axial direction of which the rotor or a shaft is mounted. If the flow channel is flowed through by a hot gas, the moving blades are subjected to a force, which is converted into a torque which acts on the shaft and drives the turbine rotor, it being possible for the rotational energy to be used for example for operating a generator.

Modern gas turbines are continually undergoing improvement to increase their efficiency. However, one of the effects of this is ever higher temperatures in the hot gas path. The metallic materials for moving blades, in particular in the first stages, are continually being improved with respect to their strength at high temperatures (creep loading, thermomechanical fatigue).

Additive manufacturing methods have proven to be particularly advantageous for components that are complex or of a filigree design, for example labyrinthine structures, cooling structures and/or lightweight structures. In particular, additive manufacturing is advantageous as a result of a particularly short chain of process steps, since a step for the manufacture or production of a component can be performed largely on the basis of a corresponding CAD file and the choice of corresponding production parameters.

Additive manufacturing methods comprise for example, as powder-bed methods, selective laser melting (SLM) or laser sintering (SLS), or electron-beam melting (EBM). Further additive methods are for example “directed energy deposition (DED)” methods, in particular laser deposition welding, electron-beam, or plasma-powder welding, wire welding, metal powder injection molding, so-called “sheet lamination” methods, or thermal spraying methods (VPS, LPPS, GDCS).

Powder-bed-based additive methods (“laser powder bed fusion” (LPBF)) have in common that a building-up direction, usually a vertical, is inherently predetermined by the method as a result of the existence and arrangement of the powder bed.

A method for selective laser melting is known for example from EP 2 601 006 B1.

On account of its disruptive potential for the industry, generative or additive manufacture is also becoming increasingly of interest for the series manufacture of the aforementioned turbine components, such as for example turbine blades or burner components.

The manufacture of cooling systems or components to be cooled from a powder bed is particularly advantageous and promising, since it is possible to dispense with complex conventional approaches to manufacturing, which require a large number of method steps, a very long throughput time and often the making of separate tools, such as casting tools.

However, the additive build-up in layers and the dependence of the built-up structure on the orientation on a building platform lead to a lack of reproducibility and to great variations in the surface quality, in particular of hollow spaces or channels, of the components that are correspondingly to be built up. In particular in the case of large hollow spaces, channels, cavities or overhanging structures defining them, a particularly great roughness or variations in the geometry of internal or external component surfaces must be expected. This is caused by a lack of mechanical support for the overhanging structures, but especially also due to a lack of heat dissipation and due to break-offs of the melt pool.

It is known that overhanging structures, that is to say structures which for example form an overhang with respect to a vertical building-up direction, can only be created or made to set with difficulty, since the melt pool for them extends at least partially into a region of loose powder during the manufacturing process. In the case of selective melting methods, the extent of the melt pool in fact usually exceeds the set layer thickness by a multiple.

In order in particular to predict or maintain control over geometry-dependent artefacts or the mentioned surface properties, in particular experimental studies are required. These in turn involve high costs and laborious product development.

Previous approaches for predicting surface roughnesses of internal surfaces or channel structures and their effects on cooling functionality and heat dissipation from the corresponding structure, for example by means of so-called CFD simulations (“computational fluid dynamics”), have so far likewise failed, or have been found to be inapplicable because of the discrepancy between simulation and practical experiment. Such simulations comprise for example measurements of the pressure loss and heat transfer at the surfaces areas of channels or cavities. Experimental research results show in particular for these mentioned parameters a dependence that is not necessarily linear.

On the other hand, making allowance for the geometry of the component to be built up, which may be provided for example by a CAD file, and also the irradiation strategy and the specific material properties offers a chance of improving the structural result and reproducibility of the additive manufacture for the components described.

### SUMMARY OF INVENTION

It is therefore an object of the present invention to provide means which create preconditions already in the preparation for the actual manufacturing process for allowing the additive manufacture of complicated structures from high-performance materials, in particular of components with cooling channels or regions to be cooled, to proceed in an improved manner, and thus also to improve decisively the component itself to be built up, with respect to the structural quality and/or functionality. In particular, the present invention allows the component to be operated at still higher temperatures—for a given cooling effort—or correspondingly the cooling efficiency to be improved—for a given operating temperature. This is of great importance in particular for the efficiency (Carnot efficiency) of turbomachines, which is known to be highly dependent on the operating temperatures of the components involved (see above).

This object is achieved by the subject matter of the independent patent claims. Advantageous designs are the subject of the dependent patent claims.

One aspect of the present invention concerns a component with a region to be cooled or a component to be cooled during operation, which has a cooling channel which is arranged and designed to cool the region of the component during operation by means of a fluid flow. Preferably, the said region is subjected to high thermal and/or mechanical loads as a result of the hot gas path of a gas turbine or a comparable application in the aerospace or automobile sector. The region is advantageously a surface region of the component or some other region of the component that is particularly subjected to thermal or thermomechanical stress during operation. The region may in particular refer to a wall, for example a wall of the component that defines a hot gas path.

The cooling channel is defined on a side near the wall or facing toward the region to be cooled by a first channel side or channel side structure.

Furthermore, the cooling channel is defined on a side away from the wall or facing away from the region to be cooled by a second channel side, different from the first channel side, or channel side structure. The first channel side forms a greater contact surface area with the cooling channel than the second channel side.

Seen in the cross section of the cooling channel, the two channel sides may enclose the cooling channel, advantageously fully circumferentially.

As soon as, during its operation as intended, the cooling channel of the component is flowed through by a cooling fluid or a fluid flow, such as for example a cooling air stream or some other medium, a greater interaction with the cooling fluid relevant for a heat transmission to the surroundings also results for the first channel side, so that the heat transfer or heat transmission on the first channel side is improved in comparison with the second channel side.

This “asymmetrical” heat transmission on the channel sides (first and second channel side) advantageously allows according to the invention specifically an optimization of the cooling fluid mass flow and heat transmission of heat of the thermally loaded region to the cooling fluid.

In one design, the greater contact surface area of the first channel side—in comparison with the second channel side—is caused by a greater roughness of the first channel side. Such an increased roughness may in particular be inherently imparted to the component by the manufacturing method.

In one design, the roughness comprises a mean roughness value and/or a root-mean-square roughness, or represents a corresponding measure. Alternatively or in addition, the estimate of the roughness may also be some other proven or valid measure of the roughness of the corresponding surface.

In one design, the cooling channel has a circular cross section. This design may be advantageous for simple channel geometries and correspondingly expediently designed regions to be cooled of the component.

In one design, the cooling channel has an elliptical cross section. This design may be advantageous in particular for regions to be cooled of the component that are of a somewhat greater surface area, and are expediently designed correspondingly. The inventive advantage described above of the optimization of the heat transmission for a given flow (given mass flow or pressure loss) can in particular be optimized by this design.

In one design, the cooling channel has a rhomboidal, trapezoidal, parallelogram-shaped or non-axially symmetrical cross section. Such a design may also be advantageous for certain channel geometries and regions to be cooled of the component that are correspondingly designed or formed. In particular, with a non-axially symmetrical cross section of the cooling channel, the ratio of the area content of the first channel side to the second channel side can be further increased, whereby the inventive advantage of the present invention is manifested even more clearly.

In one design, the component is a component that can withstand high temperature loads, such as a turbine component, in particular a hot gas component of a gas turbine.

A further aspect of the present invention concerns a method for preparing for an additive manufacturing process, in particular a powder-bed-based additive manufacturing process, for the mentioned component, wherein, in preparation for the manufacture, an orientation of the cooling channel, advantageously with respect to a longitudinal axis or main extent of the cooling channel, is chosen in relation to a building-up direction in such a way that the first channel side forms a greater roughness and/or contact surface area with the cooling channel in comparison with the second channel side on account of orientation-dependent or structural manufacturing artefacts or deviations.

With partially curved channels, the longitudinal axis may advantageously refer to a predominantly prevailing longitudinal axis or extent of the channel.

In one design, an angle between a building-up direction, for example the vertical axis (z axis), of the component and a longitudinal axis of the cooling channel is between 10° and 80°. In particular with relatively small cooling channel diameters or dimensions of less than 10 mm, the advantages according to the invention can be exploited well in the described range of angles.

In one design, the angle between the building-up direction of the component and the longitudinal axis of the cooling channel is between 30° and 60°. This design offers the advantages according to the invention in particular for a multitude of channel geometries and channel diameters.

In particular with a vertical building-up direction, angles of over 60° already mean an alignment of the channel axis close to a horizontal, which can lead to problems in the build-up for large channel geometries or hollow spaces in the component. With angles of below 30° and less, the advantages according to the invention can possibly no longer be fully exhausted, because the differences in the contact surface area of the first channel side and the second channel side and an asymmetry in the resultant velocity profiles of the fluid (compare the embodiments described below) become increasingly smaller here.

In one design, the angle between the building-up direction of the component and the longitudinal axis of the cooling channel is at most 60°.

In one design, the angle between the building-up direction of the component and the longitudinal axis of the cooling channel is at least 30°.

In one design, the angle between the building-up direction of the component and the longitudinal axis of the cooling channel is between 20° and 70°.

A further aspect of the present invention concerns a method for the powder-bed-based additive manufacture of the component comprising the described method for preparing for the manufacture.

A further aspect of the present invention concerns a use of orientation-dependent manufacturing features or manufacturing artefacts of structures additively manufactured from a powder bed for the forming of an advantageous surface finish, deviation, inhomogeneity or unevenness in the surface finish of the cooling channel of the described component, so that a heat transmission on a channel side near the wall or region is increased—in relation to a channel side away from the wall or region—for a given fluid flow or constant mass flow or pressure loss. In other words, by using the described manufacturing features or artefacts, the cooling effect and the cooling efficiency of fluid-cooled component surfaces or regions can be advantageously optimized by an improved heat transmission as a result of an optimization of the roughness of the channel surfaces.

A further aspect of the present invention concerns a computer program or computer program product or a storage medium, in particular a nonvolatile storage medium, comprising commands which, during the execution of a corresponding program by a computer, cause the latter to perform at least parts of the method for preparing for the additive manufacture of the component.

A computer program product, such as for example a computer program means, may for example be provided or included as a (volatile or nonvolatile) storage medium, such as for example a memory card, a USB stick, a CD-ROM or DVD, or else in the form of a downloadable file from a server in a network. It may also be provided for example in a wireless communication network by the transmission of a corresponding file with the computer program product or the computer program means. A computer program product may include program code, machine code, G-code and/or executable program instructions in general.

Designs, features and/or advantages which refer here to the component may also concern aspects of the method or concern the computer program product, and vice versa.

The expression “and/or” used here, when it is used in a series of two or more elements or aspects, means that any of the items listed can be used alone, or any combination of two or more elements or aspects can be used.

Further details of the invention are described below on the basis of the figures.

### BRIEF DESCRIPTION OF THE DRAWINGS

FIG. 1 shows a schematic sectional view of a component with a region to be cooled during operation.

FIG. 2 shows a schematic sectional view of the component with a cooling channel designed according to the invention.

FIG. 3 shows a schematic sectional view of the component with reference to a building-up direction of a corresponding additive manufacturing process.

FIG. 4 shows a schematic view of a velocity profile of a fluid flow in a channel of the component shown in FIG. 3.

FIG. 5 shows—by analogy with the representation of FIG. 3—an alternative alignment of the component in relation to the building-up direction.

FIG. 6 shows—by analogy with the representation of FIG. 4—a velocity profile of a fluid flow in a channel of the component shown in FIG. 5.

FIG. 7 shows a schematic cross-sectional view of a cooling channel according to the invention.

FIG. 8 shows an alternative schematic cross-sectional view of a cooling channel according to the invention.

FIG. 9 shows another alternative schematic cross-sectional view of a cooling channel according to the invention.

FIG. 10 indicates method steps according to the invention on the basis of a simple flow diagram.

### DETAILED DESCRIPTION OF INVENTION

In the exemplary embodiments and figures, elements that are the same or act in the same way may be provided in each case with the same designations. The depicted elements and their sizes in relation to one another are in principle not to be regarded as true to scale; rather, individual elements may be illustrated with exaggerated thickness or size dimensions for improved clarity and/or for improved understanding.

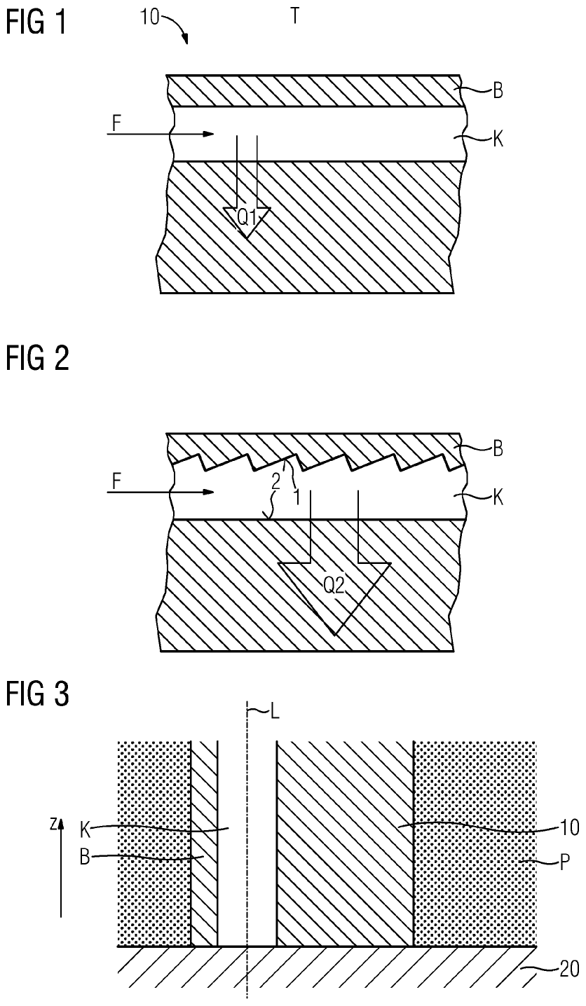

FIG. 1 shows at least part of a component 10 in a longitudinal section. The component 10 is advantageously a component of a high-temperature-resistant material of a complicated shape to be additively manufactured from the powder bed.

The component 10 has a region B to be cooled during the operation of the same. The region B advantageously defines during the operation of the component a surrounding area by which the component is subjected to high thermal loads, such as for example a hot gas path of a gas turbine. The region B may accordingly be a wall region of the component 10 or comprise a corresponding wall.

For cooling the region B, the component 10 also has a cooling channel K. The cooling channel K is advantageously flowed through during the operation of the component 10 by a cooling fluid or a fluid flow F, in order to cool the region B.

The component 10 of FIG. 1 may represent a prior-art component. In particular, the channel side or channel side structure or the surface area thereby formed or contact surface area (not explicitly indicated in FIG. 1), which determines an interaction with the cooling fluid, is advantageously uniformly designed.

As a result of cooling of the fluid flow F, a heat transmission or a heat transfer of a quantity of heat Q1 (cf. the downwardly directed arrow) advantageously takes place during the operation of the component 10 from the region B to the cooling fluid F.

FIG. 2 likewise shows in a longitudinal section analogous to FIG. 1—a component 10 according to the invention. As a difference from FIG. 1, the cooling channel K has, facing toward the region B or the wall of the component 10, advantageously circumferentially, a first channel side 1 or channel side structure.

Furthermore, the cooling channel K has, facing away from the region B or the wall of the component 10, advantageously circumferentially, a second channel side 2, which is different from the first channel side.

It is indicated by the jagged or curved contour of the first channel side 1 that this channel side forms a greater contact surface area with the cooling channel K than the second channel side 2, which is shown as straight. The greater contact surface area of the first channel side 1 may be caused for example by an increased roughness or by introduced surface features. As explained further below, these features or artefacts are advantageously inherently formed or imparted by the powder-bed-based additive manufacturing method.

The measure of the described roughness may be for example a root-mean-square roughness, a mean roughness value, an average depth of roughness or some other relevant measure.

The described differently or non-uniformly formed channel structure sides also bring about an improved heat transmission, and consequently an improved cooling effect, on the side 1 that is facing toward the region B, and is subjected to even greater thermal loads, during the operation of the component 10 without having to provide a greater cooling fluid mass flow or a greater cooling fluid pressure difference. This brings about the advantages according to the invention that are described here.

As a result of a cooling of the fluid flow F, a heat transmission or heat transfer of a quantity of heat Q2 (compare the downwardly directed arrow) from the region B to the cooling fluid advantageously takes place during the operation of the component 10.

As indicated by the correspondingly widened arrow, the quantity of heat Q2 is greater than the quantity of heat Q1 shown in FIG. 1.

In the ideal or simplified case, the heat transmission may be given or approximated as follows: Q=α·A (T1−T2)·Δt, where Q is the transmitted quantity of heat, A is the contact surface area under consideration, T1−T2 is the temperature difference, and Δt is the time interval under consideration.

FIG. 3 also shows in a schematic longitudinal section a component 10, which has a cooling channel K with a longitudinal axis L. Here, the longitudinal axis L of the cooling channel K is aligned parallel to a building-up direction z, here a vertical. The building-up direction z is also aligned perpendicularly or normal to a building platform 20 (building platform surface). Loose powder surrounding the component during the additive build-up is indicated by the designation P.

It is known that it is inherent to additive powder-bed-based manufacturing methods that the building-up direction is oriented perpendicularly on a manufacturing surface formed by the powder bed.

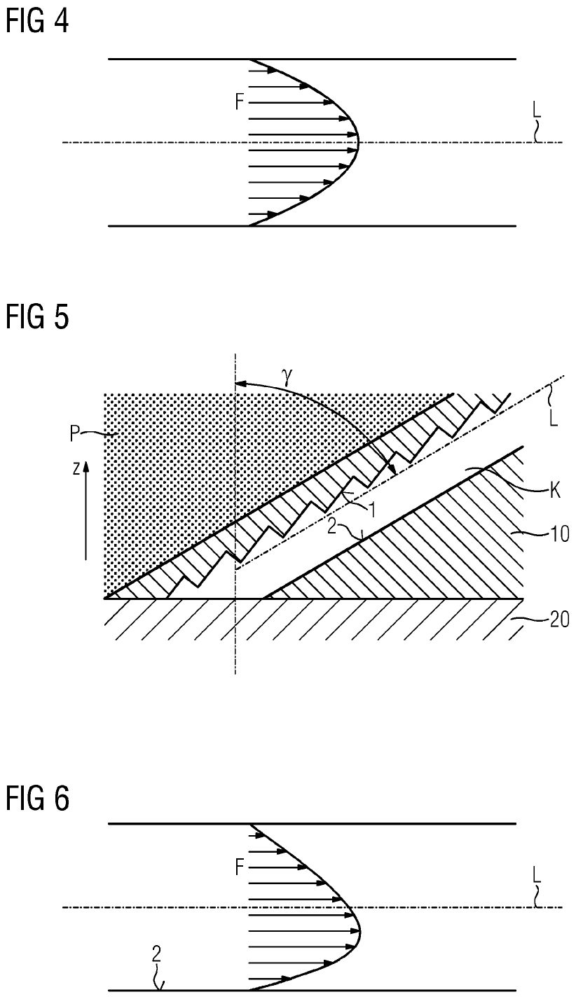

FIG. 4 schematically indicates a velocity profile of a fluid flow F through a cooling channel K correspondingly shown in FIG. 3. It can be seen in FIG. 4 that a velocity profile of the fluid flow F that is symmetrical with respect to the longitudinal axis L of the channel and is indicated by the arrows is obtained.

FIG. 5 also shows in a schematic longitudinal section a component 10 according to the invention, which, for example in the course of production planning in advance of a corresponding additive manufacturing process, is arranged in such a way in relation to the building-up direction z that an angle γ between the longitudinal axis L and the building-up direction z is obtained.

Here, the angle γ may be for example between 10° and 80°. This extended range of angles is advantageous in particular for small channel dimensions or diameters, of for example 5 to 7 mm, or less than 10 mm.

Alternatively, the angle γ may be between 20° and 70°, or assume values between 30° and 60°. In all of these mentioned ranges, the advantages according to the invention can be exploited.

In one design, the angle γ is at most 60°.

In one design, the angle γ is at least 30°.

FIG. 6 schematically indicates a velocity profile of a fluid flow F through the cooling channel correspondingly shown in FIG. 5. Here it can be seen that a velocity profile that is asymmetrical with respect to the longitudinal axis L of the channel K is obtained. This is owing to the phenomenon that, as described above, the first channel side forms a greater roughness, for example caused inherently by the production, and a greater contact surface area with the cooling channel K or with the fluid flow F passed through it during operation.

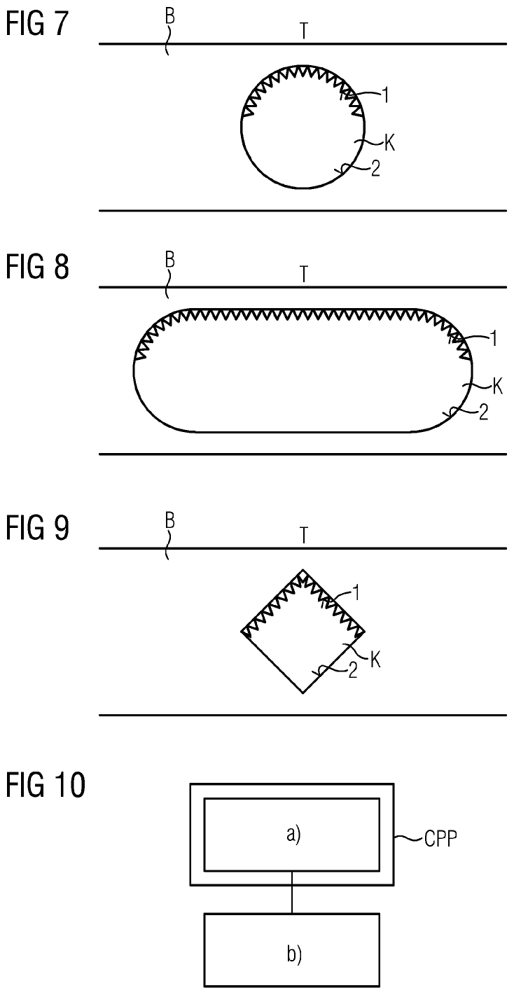

FIG. 7 shows a schematic cross-sectional view of a channel K according to the invention. According to this design, the channel has a circular cross section.

FIG. 8 shows a schematic cross-sectional view of a channel K according to the invention. According to this design, the channel has an elliptical cross section.

FIG. 9 shows a schematic cross-sectional view of a channel K according to the invention. According to this design, the channel has a rhomboidal cross section.

Although this is not explicitly indicated in the figures, according to the invention the cross section of the channel K may have different shapes, for example non-axially symmetrical shapes, such as the shape of a droplet, wherein the short side of the droplet may be facing toward the region B, the shape of a trapezoid, a parallelogram-like shape or some other shape.

FIG. 10 indicates on the basis of a schematic flow diagram method steps according to the invention which comprise both preparation already for a corresponding powder-bed-based additive manufacturing process for the component 10 and the actual physical additive manufacture of the same.

The method indicated by way of example comprises method steps a) and b).

Method step a) is intended in particular to represent a method for preparing for a powder-bed-based additive manufacturing process of a component (10), wherein an orientation of the cooling channel K in relation to a building-up direction z is chosen in preparation for manufacture in such a way that the first channel side 1 forms a greater contact surface area with the cooling channel K—as described—in comparison with the second channel side 2 on account of orientation-dependent or structural manufacturing artefacts.

The mentioned preparation for manufacture may for example take the form of establishing a suitable irradiation strategy or establishing irradiation parameters (such as laser power, pulsing or hatch spacing) and take the form of so-called CAM data (computer-aided-manufacturing). Accordingly, this method step may for example be at least partially performed by a computer program or computer program product CPP. This is a particularly advantageous design of the preparation for the process, in particular in view of a number of individual irradiation vectors for complex components of possibly several millions.

By contrast, method step b) is intended to represent the actual physical additive manufacture of the component according to the described preparation for the process.

The component is advantageously a component that is used in the hot gas path of a turbomachine, for example a gas turbine. In particular, the component may be a moving or stationary blade, a segment or ring segment, a burner part or a burner tip, a frame, a shield, a heat shield, a nozzle, a seal, a filter, an orifice or lance, a resonator, a prop or a turbulator, or a corresponding junction, an insert, or a corresponding retrofitted part.

Although, in the figures described, the design according to the invention of the channel side structure of the first channel side is only simplified and zigzag-like, and primarily a roughness is representatively indicated, the advantages according to the invention can likewise be specifically incorporated—by for example features induced by a specific irradiation strategy that increase the turbulence of the flow and consequently the heat dissipation from the region B into the fluid F.

The invention is not restricted by the description on the basis of the exemplary embodiments to these embodiments, but rather comprises any novel feature and any combination of features. This includes in particular any combination of features in the patent claims, even if this feature or this combination itself is not explicitly specified in the patent claims or exemplary embodiments.

1. A component with a region to be cooled, comprising:
a cooling channel, which is arranged and designed to cool the region of the component during operation by a fluid flow,
wherein the cooling channel is defined—facing toward the region—by a first channel side and—facing away from the region—by a second channel side, and
wherein the first channel side forms a greater contact surface area with the cooling channel than the second channel side.

2. The component as claimed in claim 1,
wherein the greater contact surface area of the first channel side—in comparison with the second channel side—is caused by a greater roughness of the first channel side.

3. The component as claimed in claim 2,
wherein the roughness comprises a mean roughness value and/or a root-mean-square roughness.

4. The component as claimed in claim 1,
wherein the cooling channel has a circular cross section.

5. The component as claimed in claim 1,
wherein the cooling channel has an elliptical cross section.

6. The component as claimed in claim 1,
wherein the cooling channel has a rhomboidal cross section.

7. The component as claimed in claim 1,
wherein the component is a component that can withstand high temperature loads.

8. A method for preparing for a powder-bed-based additive manufacturing process for a component as claimed in claim 1, the method comprising:
choosing, in preparation for the manufacture, an orientation of the cooling channel is in relation to a building-up direction in such a way that the first channel side forms a greater contact surface area with the cooling channel in comparison with the second channel side on account of orientation-dependent manufacturing artefacts.

9. The method as claimed in claim 8,
wherein an angle between a building-up direction of the component and a longitudinal axis of the cooling channel is between 30° and 60°.

10. The method as claimed in claim 8,
wherein an angle between a building-up direction of the component and a longitudinal axis of the cooling channel is at most 60°.

11. The method as claimed in claim 8,
wherein an angle between the building-up direction of the component and a longitudinal axis of the cooling channel is at least 30°.

12. A method for the powder-bed-based additive manufacture of a component, comprising:
preparing for a powder-bed-based additive manufacturing process according to the method for preparation as claimed in claim 8.

13. A method of manufacturing, comprising:
using orientation-dependent manufacturing artefacts of structures additively manufactured from a powder bed, for the forming of a deviation in the surface finish of a cooling channel of a component with a region to be cooled, so that a heat transmission on a channel side near the wall or region is increased—in relation to a channel side away from the wall or region—for a given fluid flow.

14. A non-transitory computer readable medium, comprising:
commands stored thereon which, during execution by a computer, cause the computer to perform the method as claimed in claim 8.

15. The component as claimed in claim 7,
wherein the component comprises a turbine component and/or a hot gas component of a gas turbine.
